(19) United States
(12) Patent Application Publication
(10) Pub. No.: US 2022/0363802 A1
(43) Pub. Date: Nov. 17, 2022

(54) DEGRADABLE POLYMER COMPOSITION AND METHODS OF MANUFACTURING AND USING IN DOWNHOLE TOOLS

(71) Applicants: CNPC USA Corporation, Houston, TX (US); Beijing Huamei, Inc., Beijing (CN)

(72) Inventors: Jiaxiang REN, Katy, TX (US); Peng CHENG, Houston, TX (US)

(21) Appl. No.: 17/239,680

(22) Filed: Apr. 25, 2021

(51) Int. Cl. C08G 18/10; C08G 18/44; C08G 18/48; C08G 18/22; E21B 33/12

(52) U.S. Cl. CPC C08G 18/10; C08G 18/44; C08G 18/48; C08G 18/225; E21B 33/12; C08G 2230/00

(57) ABSTRACT

A chemical composition for a degradable polymeric material includes an isocyanate terminated prepolymer, including prepolymer units as a main chain with a plurality of isocynanates at ends of the main chain, a catalyst additive, and a cross-linking agent. The isocyanate terminated prepolymer can be an isocyanate terminated polyester, polycarbonate or polyether prepolymer. The isocyanate terminated prepolymer has a structural formula as follows:

ONC—R″—NH—[—CO—R—CO—O—R′—O—]n—NH—R″—CNO

wherein R, R′ and R″ are an aryl group or alkyl group and wherein n is a number of prepolymer units corresponding to length of the main chain. The composition degrades at a rate and at a delay for failure between 8-72 hours. The composition is a dissolvable rubber material with a modulus and elongation suitable for a component of a downhole tool.

### CROSS-REFERENCE TO RELATED APPLICATIONS

Not applicable. See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention relates to a material composition in the oil and gas industry. More particularly, the present invention relates to degradable polymer compositions to form components of downhole tools. Even more particularly, the present invention relates to a water dissolvable elastomer with modulus and elongation suitable for sealing components of downhole tools.

### 2. Description of Related Art Including Information Disclosed Under 37 CFR 1.97 and 37 CFR 1.98.

A plug is a downhole tool used in oil and gas operations. Non-conventional oil and gas production has replaced millable composite plugs with dissolvable plugs in downhole operations, like fracturing operations. After the fracturing, the dissolvable plug is dissolved in the downhole fluids. Milling to remove a milling composite plug is no longer required. Therefore, the operation time and costs of milling were saved. A dissolvable elastomer or degradable polymer is an essential component of each dissolvable plug because a dissolvable plug still requires sealing. Even the material for sealing must be degradable along with the other hard components of the dissolvable plug. A degradable polymer is used as a sealing material needed for dissolvable plugs.

The degradable polymer or dissolvable elastomer still must be capable of sealing other materials. Maintaining sufficient elasticity for certain time period, such as more than 12 hours to complete a fracturing operation, is a necessary feature of a degradable polymer for a dissolvable downhole tool, such as a dissolvable plug. Additionally, the degradable polymer or dissolvable elastomer must be capable of degrading or dissolving as fast as possible in the downhole fluid after performing the fracturing operation.

The disclosure of degradable polymers or dissolvable elastomers or dissolvable rubbers are known in the prior art intended for a variety of conditions. US Publication No. 20170152371 published on 1 Jun. 2017 for Duan et al, U.S. Pat. No. 9790763 (the '763 patent), issued on 17 Oct. 2017 to Fripp et al, and US Publication No. 20170158942, published on 8 Jun. 2017 for Okura et al. disclose degradable polymers.

The '763 patent discloses a method to manufacture high strength degradable rubber with controlled dissolution rates. The degradable rubber is a polyester-polyurethane copolymer and copolymer was crosslinked with selective cross-linkers. The dissolution rate was accelerated by mixing with selective catalysts. The dissolution rate of the degradable rubber is faster than the typical degradable rubbers in the market.

This invention discloses an improved high modulus and high elongation water degradable polymer material and its application in downhole oil tools. The high modulus and high elongation water degradable polymer material displayed faster dissolution rates than the dissolvable polymers in the market. There is a need for a higher modulus and higher elongation than possible with the traditional elastomers and other dissolvable elastomers in the market. The degradable polymer could be used as sealing materials for many downhole tools, including but not limited to fracture plugs, bridge plugs, packers, isolation valves, etc.

It is an object of the present invention to provide a degradable polymeric material.

It is another object of the present invention to provide a degradable polymeric material for components of a downhole tool.

It is still another object of the present invention to provide a degradable polymeric material with modulus and elongation for components of a downhole tool.

It is still another object of the present invention to provide a degradable polymeric material with dissolvability to control in downhole operations.

It is yet another object of the present invention to provide a degradable polymeric material with dissolvability compatible for fluids with different salinities.

It is an object of the present invention to provide a method of forming a degradable polymeric material for components of a downhole tool.

It is an object of the present invention to provide a method of using a degradable polymeric material in a component of a downhole tool.

These and other objectives and advantages of the present invention will become apparent from a reading of the attached specification.

### BRIEF SUMMARY OF THE INVENTION

Embodiments of the chemical composition for a degradable polymeric material of the present invention include an isocyanate terminated prepolymer, a catalyst additive, and a cross-linking agent. The isocyanate terminated prepolymer includes prepolymer units as a main chain with a plurality of isocynanates at ends of the main chain with a cross-linking agent so as to be able to form a material suitable for components of a downhole tool. The isocyanate terminated prepolymer can be an isocyanate terminated polyester, polycarbonate, or polyether prepolymer. The composition dissolves or degrades at a controlled rate so as to maintain integrity for a downhole operation. The composition can also dissolve or degrade quickly after the downhole operation is completed. The composition has a high modulus and high elongation to hold high pressure differentials of a sealing component of a downhole tool during downhole operations, while remaining dissolvable.

Embodiments of the present invention also include the method of forming the degradable polymeric material. The method includes vacuuming the isocyanate terminated prepolymer, vacuuming the cross-linking agent, mixing the isocyanate terminated prepolymer, the catalyst additive, and the cross-linking agent so as to form a mixture, and molding the mixture so as to form a cured polymer as a component. The step of mixing can be by centrifuge and can be under vacuum. The step of molding can include cast molding, rotational molding, or compression molding. Alternate embodiments include adding a filler during the step of mixing.

The method of using the degradable polymeric material is another embodiment of the present invention, in particular, removal of a downhole tool after a fracturing operation. The method for removal can include forming the chemical composition of the degradable polymeric material into a component, installing the component in an assembly, such as a downhole tool, dissolving the component in aqueous solution into a degraded component, and collapsing the assembly so as to remove the assembly and the degraded component.

### BRIEF DESCRIPTION OF THE SEVERAL VIEWS OF THE DRAWINGS

FIGS. 1a-1e are sets of photos illustrating fracturing failure of embodiments of degradable polymeric materials according to the present invention. FIG. 1a shows fracture failure of a prior art material commercial dissolvable rubber in 0.3% KCl at 90 degrees Celsius. FIG. 1b shows fracture failure of an embodiment of the present invention CNPC-MTDR-1 in 0.3% KCl at 80 degrees Celsius. FIG. 1c shows fracture failure of an embodiment of the present invention CNPC-MTDR-1 in 0.3% KCl at 80 degrees Celsius. FIG. 1d shows fracture failure of an embodiment of the present invention CNPC-HTDR-1 in 0.3% KCl at 95 degrees Celsius. FIG. 1e shows fracture failure of an embodiment of the present invention CNPC-LTDR-1 in 0.3% KCl at 50 degrees Celsius.

FIG. 2 is a graph illustration of weight change and time, showing dissolution rates of the prior art and an embodiment of the degradable polymeric material according to the present invention (CNPC-MTDR-1) in 0.3% KCl at 80 degrees Celsius.

FIG. 3 is a graph illustration of stress and strain, showing the prior art and an embodiment of the degradable polymeric material according to the present invention (CNPC-MTDR-1) at 100 degrees Celsius.

FIG. 4 is a graph illustration of weight change and time, showing dissolution rates of the prior art and an embodiment of the degradable polymeric material according to the present invention (CNPC-HTDR-1) in 0.3% KCl at 95 degrees Celsius.

FIG. 5 is a graph illustration of pressure and temperature against time, showing pressure holding of an embodiment of the degradable polymeric material according to the present invention (CNPC-MTDR-1) in water at 100 degrees Celsius.

### DETAILED DESCRIPTION OF THE INVENTION

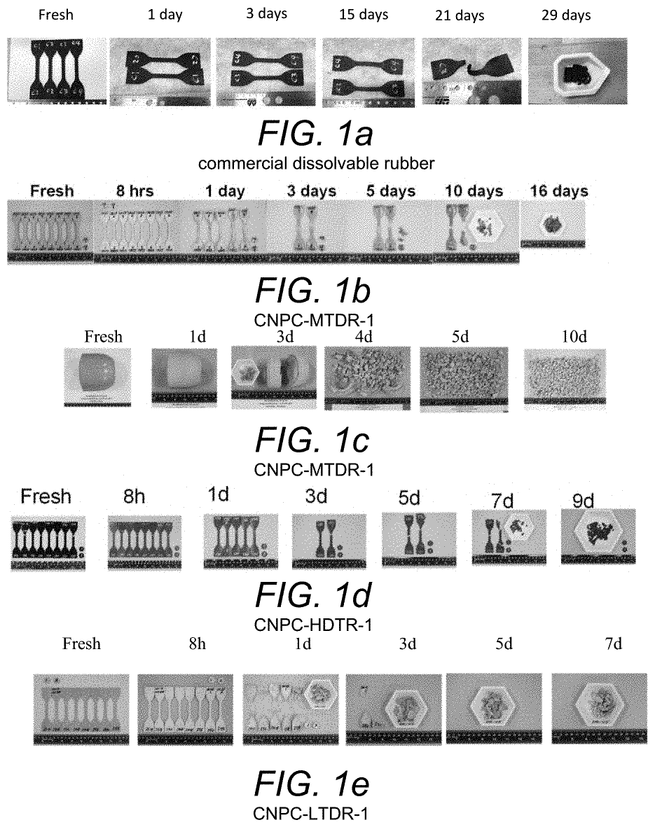

FIGS. 1(a-e) to 5 show the chemical composition of the present invention as a degradable polymeric material compatible for the conditions associated with downhole operations, such as hydraulic fracturing operations. When the chemical composition is formed in a component of a downhole tool, the component must have the same functionality as the conventional non-dissolving component. The component must be sufficiently strong to seal and hold a pressure differential as assembled in the downhole tool. The component must also properly dissolve in a wellbore fluid, such as a potassium chloride brine, after the downhole operation is completed. The chemical composition must not immediately dissolve too quickly in order to perform the downhole operation, while also dissolve quickly when the downhole operation is completed.

The chemical composition of the present invention is a degradable or dissolvable polymeric material being comprised of an isocyanate terminated prepolymer, a catalyst additive, and a cross-linking agent. The isocyanate terminated prepolymer includes prepolymer units as a main chain with a plurality of isocynanates at ends of the main chain with a cross-linking agent so as to be able to form a material suitable for components of a downhole tool. The isocyanate terminated prepolymer can be an isocyanate terminated polyester, polycarbonate, or polyether prepolymer. The structure of the isocyanate terminated prepolymer can be shown as below.

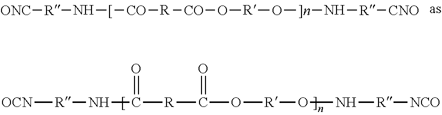

wherein R is an aryl group or alkyl group, wherein R′ is an aryl group or alkyl group, wherein R″ is an aryl group or alkyl group, and wherein n is a number of prepolymer units repeated corresponding to length of said main chain.

The isocyanate can be comprised of a low free isocyanate toluene di-isocyanate (TDI), which is helpful to achieve narrow molecular distribution, virtual crosslinking, and more defined hard-phase and soft phase separation to achieve better mechanical properties.

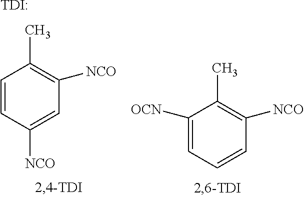

The isocyanate could also be, but not limited to methylene diphenyl diisocyanate (MDI), para-phenyl diisocyanate (pPDI), hexamethylene isocyanate (HDI) etc.

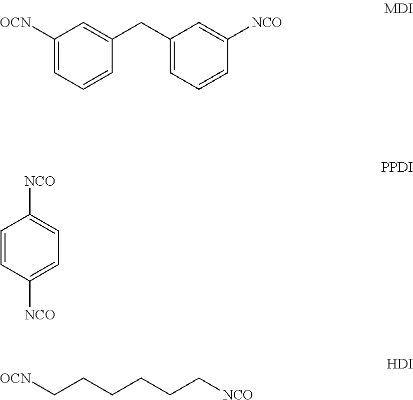

The cross-linking agent or cross linker can be diamine 4,4′ methylene-bis-(o-chloroaniline), dimethyl thio-toluene diamine, diols, such as butanediol, polycarbonate polyols, polyester glycol, or triols.

4,4′ methylene-bis-(o-chloroaniline):

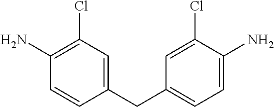 [SMILES: Nc1ccc(Cc2ccc(N)c(Cl)c2)cc1Cl]

Dimethyl thio-toluene diamine:

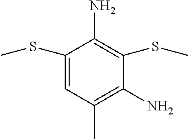

The catalyst additive is comprised of a metal oxide, a base additive or both. The metal oxide can be sodium oxide, potassium oxide, calcium oxide, or magnesium oxide. The base additive can be a metal hydroxide or a Lewis base, and the metal hydroxide can be sodium hydroxide, potassium hydroxide, calcium hydroxide, or magnesium hydroxide.

The strength of the chemical composition of the present invention can be further enhanced by incorporating fillers, such as carbon blacks, silica, nanographene, nanoclays, nanofibers, nanotubes, etc.

TABLE 1
Description of embodiments of the invention

| Formulation | Hardness | | |
|---|---|---|---|
| Name | (Shore A) | Polymer Desciption | Catalyst Additive |
| CNPC-MTDR-1 | 93 | Medium temperature dissolvable | metal oxide |
| | | rubber based on Polyester- | |
| | | polurethane coopolymer | |
| CNPC-LTDR-1 | 85 | Low temperature dissolvable | metal oxide with base additive |
| | | rubber based on Polyester- | |
| | | polurethane coopolymer | |
| CNPC-HTDR-1 | 95 | High temperature dissolvable | Base additive |
| | | rubber based on Polyester- | |
| | | polurethane coopolymer | |

One method to make the dissolvable polymer is to mix the proper ratio of isocyanate terminated polyester prepolymer, the catalyst additive, and the cross-linking agent. There can also be reinforcing agent, pigments, surfactants, etc. The isocyanate terminated prepolymer and cross-linking agent were vacuumed before mixing. The mixing is achieved with centrifuge mixing or other mixing method either under vacuum or not. The mixer was then casted in a mold and then performed casting molding or rotational molding. The isocyanate terminated prepolymer can be an isocyanate terminated polyester, polycarbonate, or polyether prepolymer. The cured polymers were then demolded as a component and possibly post-cured. The mixture could be also compression molded in the mold until the mixture was fully cured.

Embodiments of the method for formation of a degradable polymeric material include vacuuming the isocyanate terminated prepolymer of the chemical composition of the present invention, vacuuming the cross-linking agent, mixing the isocyanate terminated prepolymer, the catalyst additive, and the cross-linking agent so as to form a mixture, and molding the mixture so as to form a cured polymer as a component.

The step of mixing the isocyanate terminated prepolymer, the cross-linking agent, and the catalyst is by centrifuge and can be under vacuum. Additionally, the step of mixing the isocyanate terminated prepolymer, the cross-linking agent, and the catalyst further comprises adding a filler. The filler is selected from a group consisting of carbon blacks, silica, nanographene, nanoclays, nanofibers, and nanotubes. The step of molding the mixture comprises casting the mixture into a mold and curing the mixture or casting the mixture into a mold, rotating the mold, and curing the mixture or casting the mixture into a mold, compressing the mixture in the mold, and curing the mixture.

FIG. 1a shows fracture failure of a prior art rubber material commercial dissolvable rubber in 0.3% KCl at 90 degrees Celsius. The material is intact after 15 days, and the only evidence of fracture failure is at 21 days. This time to dissolve can be controlled, while still being suitable for use as a downhole tool component. The present invention can reach fracturing failure between 8-72 hours, display more than 60% weight change within 10 days, and maintain over an 8000 psi pressure differential over 24 hours. While temperature and salinity affect the time to dissolve, the material composition must be able to react properly. The salinity can also be zero, as in water. The concern of the present invention is not simply dissolving within a particular time window. The material composition must also maintain modulus and elongation so that the material is functional, while dissolving depending on temperature and not affected by salinity.

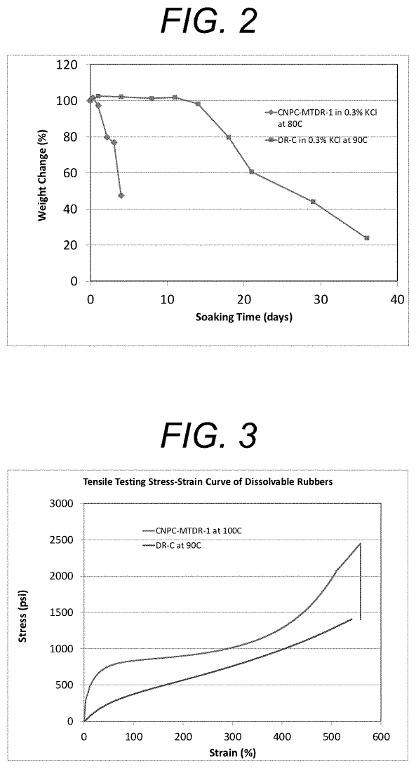

One embodiment of the present invention is CNPC-MTDR-1 with the catalyst additive as a metal oxide. FIG. 1b shows fracture failure of an embodiment of the present invention in 0.3% KCl at 80 degrees Celsius. FIG. 1c also shows fracture failure of an embodiment of the present invention CNPC-MTDR-1 in 0.3% KCl at 80 degrees Celsius. In these embodiments, the fracturing failure is between 24-72 hours in an aqueous solution between 50-130 degrees Celsius, in particular a solution of 0.3% KCl at 80 degrees Celsius. CNPC-MTDR-1 is intact after 24 hours and can be functional in a downhole tool component. FIG. 2 further shows that the present invention displays more than 60% weight change within 10 days in an aqueous solution between 50-130 degrees Celsius, in particular a solution of 0.3% KCl at 80 degrees Celsius. FIG. 3 shows a stress-strain curve increase faster over 1000 psi and over 300% strain than less than 1000 psi and less than 300% strain. Thus, the present invention has a 100% modulus higher than 400 psi and an elongation higher than 300% between 50-130 degrees Celsius. Again, the innovation is the identified balance between being able to dissolve, while still being functional (high modulus, high elongation) in terms of strength for a material of a downhole tool component.

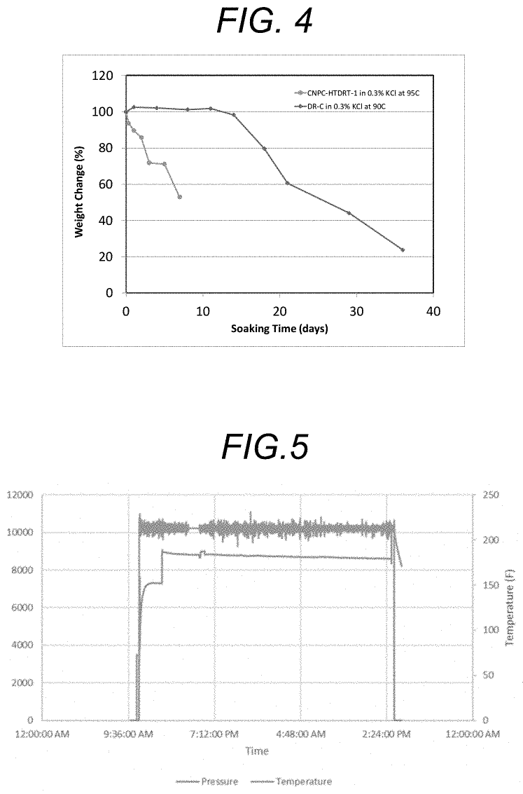

Another embodiment of the present invention is CNPC-HTDR-1 with the catalyst additive as a base additive. The base additive is a metal hydroxide. FIG. 1d shows fracture failure of an embodiment of the present invention CNPC-HTDR-1 in an aqueous solution between 50-130 degrees Celsius, in particular a solution of 0.3% KCl at 95 degrees Celsius. In this embodiment, the fracturing failure is between 24-72 hours in in aqueous solution between 90-130 degrees Celsius, such as a solution of 0.3% KCl at 95 degrees Celsius. CNPC-HTDR-1 is also intact after 24 hours or 1 day and can be functional in a downhole tool component. FIG. 4 further shows that the present invention displays more than 60% weight change within 10 days in an aqueous solution between 50-130 degrees Celsius, in particular a solution of 0.3% KCl at 95 degrees Celsius. While dissolving faster than the prior art dissolvable rubber of FIG. 1a, similar to the embodiment of CNPC-MTDR-1, the innovation is the identified balance between being able to dissolve, while still being functional (high modulus, high elongation) in terms of strength for a material of a downhole tool component.

Still another embodiment of the present invention is CNPC-LTDR-1 with the catalyst additive as both the metal oxide and a base additive. The base additive is still a metal hydroxide. FIG. 1e shows fracture failure of an embodiment of the present invention CNPC-LTDR-1 in an aqueous solution between 40-50 degrees Celsius, in particular a solution of 0.3% KCl at 50 degrees Celsius. In this embodiment, the fracturing failure is between 8-24 hours in 0.3% KCl at 50 degrees Celsius. CNPC-LTDR-1 is a fast dissolvable material but can still be functional in a downhole tool component. FIG. 5 further shows that the present invention maintains over an 8000 psi pressure differential over 24 hours in an aqueous solution between 50-130 degrees Celsius, in particular a solution of water at over 100 degrees Celsius. While dissolving fast, the present invention can still maintain a seal as the material is dissolving. The embodiment identifies balance between being able to dissolve, while still being functional (high modulus, high elongation) in terms of maintaining pressure for a sealing component of a downhole tool. Thus, the embodiments of the chemical composition of the present invention can be used as the sealing component of a dissolvable frac plugs, bridge plugs, packers, etc.

FIG. 1c shows the method for removal of a downhole tool. The downhole tool can be an assembly of components, and one of those components can be made of an embodiment of the chemical composition of the present invention. The method comprising the steps of: forming the chemical composition according to present invention into a component, installing the component in an assembly, such as a downhole tool, dissolving the component in an aqueous solution between 50-130 degrees Celsius, in particular a solution of 0.3% KCl at 80 degrees Celsius, into a degraded component, and collapsing the assembly so as to remove the assembly and the degraded component.

The invention provides a high modulus, high elongation degradable polymeric material or dissolvable rubber material composition, and the method of manufacturing the composition. The invention also discloses methods to use the chemical composition to make a component with a dissolving rate that can be controlled by cross-linking agents and catalyst additives.

The present invention provides a high strength, high modulus, flexible water dissolvable rubber material made of a polyester-polyurethane copolymer. The copolymer can be a low free isocyanate TDI terminated polymer crosslinked with various cross-linking agents. The isocyanate terminated prepolymer can be an isocyanate terminated polyester, polycarbonate, or polyether prepolymer. The cross-linking agent or crosslinker can include diamines, diols, triols, etc. Particular cross-linking agents include diamines, such as 4,4′ methylene-bis-(o-chloroaniline), and Dimethyl thio-toluene diamine.

Embodiments of the invention include filler to increase the strength of the embodiments of the chemical composition of the present invention. Fillers can be carbon blacks, silica, nanographene, nanoclay, nanofibers, nanotubes, etc.

The embodiments of the chemical composition of the present invention as dissolvable rubbers have the applications in oil and gas downhole completion, drilling, measurement tools, such as dissolvable plug, packers, isolation valves, etc. The composition can also have a modulus and elongation sufficient to hold high pressure differentials of a sealing component of a downhole tool during downhole operations, while remaining dissolvable.

The foregoing disclosure and description of the invention is illustrative and explanatory thereof. Various changes in the details of the illustrated structures, construction and method can be made without departing from the true spirit of the invention.

We claim:

1. A chemical composition for a degradable polymeric material, the chemical composition comprising:
an isocyanate terminated prepolymer, being comprised of prepolymer units as a main chain with a plurality of isocynanates at ends of said main chain, said isocyanate terminated prepolymer having a structural formula below: 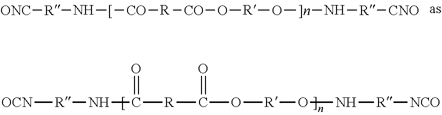
wherein R is an aryl group or alkyl group,
wherein R′ is an aryl group or alkyl group,
wherein R″ is an aryl group or alkyl group,
wherein said isocyanate terminated prepolymer is selected from a group consisting of: an isocyanate terminated polyester prepolymer, an isocyanate terminated polycarbonate prepolymer, and isocyanate terminated polyether prepolymer, and
wherein n is a number of prepolymer units corresponding to length of said main chain;
a catalyst additive being comprised of at least one of a group consisting of a metal oxide and a base additive; and
a cross-linking agent so as to reach fracturing failure between 8-72 hours, display more than 60% weight change within 10 days, and maintain over an 8000 psi pressure differential over 24 hours depending on temperature in water.

2. The chemical composition of claim 1, wherein said isocyanates are selected from a group consisting of: 2,4-toluene di-isocyanate, 2,6 toluene di-isocyanate, methylene diphenyl diisocyanate (MDI), para-phenyl diisocyanate (pPDI), and hexamethylene isocyanate (HDI).

3. The chemical composition of claim 1, wherein said catalyst is comprised of said metal oxide, said metal oxide being selected from a group consisting of: sodium oxide, potassium oxide, calcium oxide, and magnesium oxide.

4. The chemical composition of claim 3, wherein said catalyst is further comprised of said metal oxide and said base additive, said base additive being comprised of a metal hydroxide or a Lewis base.

5. The chemical composition of claim 4, wherein said metal hydroxide is selected from a group consisting of: sodium hydroxide, potassium hydroxide, calcium hydroxide, and magnesium hydroxide.

6. The chemical composition of claim 1, wherein said catalyst is comprised of said base additive, said base additive being comprised of a metal hydroxide.

7. The chemical composition of claim 6, wherein said metal hydroxide is selected from a group consisting of: sodium hydroxide, potassium hydroxide, calcium hydroxide, and magnesium hydroxide.

8. The chemical composition of claim 1, wherein said catalyst is comprised of said metal oxide so as to reach fracturing failure between 8-72 hours in aqueous solution between 50-130 degrees Celsius, display more than 60% weight change within 10 days in in aqueous solution between 50-130 degrees Celsius, and maintain over an 8000 psi pressure differential over 24 hours depending in in aqueous solution between 50-130 degrees Celsius.

9. The chemical composition of claim 8, wherein said metal oxide being selected from a group consisting of: sodium oxide, potassium oxide, calcium oxide, and magnesium oxide.

10. The chemical composition of claim 8, wherein said catalyst is comprised of said metal oxide so as to reach fracturing failure between 24-72 hours in aqueous solution between 50-130 degrees Celsius.

11. The chemical composition of claim 8, wherein said catalyst is comprised of said metal oxide so as to have a 100% modulus higher than 400 psi and an elongation higher than 300% between 50-130 degrees Celsius.

12. The chemical composition of claim 1, wherein said catalyst is further comprised of said metal oxide and said base additive so as to reach fracturing failure between 8-24 hours in aqueous solution between 40-50 degrees Celsius and maintain over an 8000 psi pressure differential over 24 hours in aqueous solution between 40-50 degrees Celsius.

13. The chemical composition of claim 12, wherein said base additive is comprised of a metal hydroxide.

14. The chemical composition of claim 13, wherein said metal oxide is selected from a group consisting of: sodium oxide, potassium oxide, calcium oxide, and magnesium oxide.

15. The chemical composition of claim 13, wherein said metal hydroxide is selected from a group consisting of: sodium hydroxide, potassium hydroxide, calcium hydroxide, and magnesium hydroxide.

16. The chemical composition of claim 1, wherein said catalyst is comprised of said base additive so as to reach fracturing failure between 24-72 hours in hours in aqueous solution between 90-130 degrees Celsius and display more than 60% weight change within 10 days in hours in aqueous solution between 90-130 degrees Celsius.

17. The chemical composition of claim 16, wherein said base additive is comprised of a metal hydroxide.

18. The chemical composition of claim 17, wherein said metal hydroxide is selected from a group consisting of: sodium hydroxide, potassium hydroxide, calcium hydroxide, and magnesium hydroxide.

19. A method for formation of a degradable polymeric material, the method comprising the steps of:
vacuuming said isocyanate terminated prepolymer of claim 1;
vacuuming said cross-linking agent;
mixing said isocyanate terminated prepolymer, said catalyst additive, and said cross-linking agent so as to form a mixture; and
molding said mixture so as to form a cured polymer as a component.

20. A method for removal, the method comprising the steps of:
forming a chemical composition according to claim 1 into a component;
installing said component in an assembly;
dissolving said component in an aqueous solution into a degraded component; and
collapsing said assembly so as to remove said assembly and said degraded component.
